(19) United States
(12) Patent Application Publication
(10) Pub. No.: US 2002/0067121 A1
(43) Pub. Date: Jun. 6, 2002

(54) Color fluorescent lamp

(76) Inventors: Ruey-Feng Jean, Tainan (TW); Chih-Fang Chen, Chu-Nan Chen (TW); Kuang-Lung Tsai, Hsinchu (TW); Lai-Cheng Chen, Taipei (TW)

Correspondence Address: J.C. Patents, Inc., 4 Venture, Suite 250, Irvine, CA, 92618, US

(21) Appl. No.: 09/967,716

(22) Filed: Sep. 27, 2001

(30) Foreign Application Priority Data
Dec. 1, 2000 (TW) 89125575

(51) Int. Cl. H01J 1/62

(52) U.S. Cl. 313/485

(57) ABSTRACT

A color fluorescent lamp, having at least a closed cavity filled with an inert gas, at least two fluorescent layers coated on an interior wall of the cavity, and a set of electrodes. The fluorescent layers have fluorescent material to emit different color lights. The set of electrodes is located inside of the cavity. A high voltage is applied to the set of electrodes, so that the noble gas electrons are induced inside of the cavity, which then emits an ultra-violet light. Being excited by the ultra-violet light, a visible light is emitted from the fluorescent layers.

### CROSS-REFERENCE TO RELATED APPLICATION

This application claims the priority benefit of Taiwan application Ser. no. 89125575, filed Dec. 1, 2000.

### BACKGROUND OF THE INVENTION

1. Field of the Invention

The invention relates in general to a method of fabricating a planar fluorescent lamp, and more particularly, to a method of fabricating a color planar fluorescent lamp.

2. Description of the Related Art

The structure of a conventional fluorescent lamp has electrodes disposed at two sides of a glass tube. The interior wall of the glass tube is coated with fluorescent material, and the tube is filled with mercury and inert gas. By applying a voltage to the electrodes, electrons are generated to bombard the mercury vapor and the inert gas, which then leap to an excited state. When the mercury vapor and the inert gas returns to the ground state, an ultra-violet light is emitted to excite the fluorescent material to emit a visible light. Due to the high brightness, the fluorescent lamp is broadly applied to many information transmission mechanisms such as the score board in a large stadium, the public electronic display, sign boards on freeways and road condition displays. The display screen of these large electronic displays is formed of many small luminescent devices. The technique for fabricating the small luminescent devices includes incandescent light bulbs, small cathode ray tube (CRT), high voltage vacuum fluorescent displays (HVVFD), small fluorescent lamps, and light emitting diodes (LED) Among these five techniques, the cathode ray tube, the high voltage vacuum fluorescent tube and light emitting diode (LED) can be applied to large screen to display color dynamic image.

The back light source used in a conventional liquid crystal display is a flat panel illumination source that can emit a white light with a uniform brightness. However, to apply to other displays, white light is not enough. Other color fluorescent lamps able to emit various color lights are required. Fluorescent materials able to emit various color lights were coated on an interior wall of the fluorescent lamp in the prior art. However, such method is very complex since different fluorescent materials have to be developed for emitting color light

### SUMMARY OF THE INVENTION

The invention provides a color fluorescent lamp structure that can easily obtain emission of various colors of lights.

The invention provides a color fluorescent lamp with a pattern to obtain various color patterns on the surface of the fluorescent lamp after when it is conducted.

In a first embodiment, a closed cavity is filled with an inert gas or a mercury vapor. At least two fluorescent layers are coated on an interior wall of the closed cavity The material of the fluorescent layers can emit various color lights. The closed cavity has a set of electrodes. Being applied with a high voltage, electrons are induced along an electric field across the electrodes to bombard the inert gas or the mercury vapor, so that an ultra-violet light is emitted. The ultra-violet light then excites the fluorescent layers to emit various color lights. According to the theory of three primitive colors, the required color light can be obtained by mixing the red light, the green light, the blue light and the white light. In addition, the brightness, color scale and gray scale of light is also adjustable by controlling the thickness of the fluorescent layers.

In a second embodiment of the invention, a color fluorescent light with a closed cavity is provided. An inert gas or a mercury gas is filled in the closed cavity. An interior wall of the closed cavity is divided into different areas, on which different fluorescent materials are coated. At least of the fluorescent materials is coated. The closed cavity further has a set of electrodes. By applying a high voltage across the electrodes, an electric field is produced to induce electrons jumping from one electrode to the other. The inert gas or the mercury vapor is excited to emit an ultra-violet light, which then excites the fluorescent layer to emit various color lights. According to the theory of three primitive colors, the required color light can be obtained by mixing the red light, the green light, the blue light and the white light. In addition, the brightness, color scale and gray scale of light is also adjustable by controlling the thickness of the fluorescent layers.

In a third embodiment of the invention, a planar color fluorescent lamp is provided. The planar color fluorescent lamp comprises a lamp base with a thickness of about 2 mm to about 5 mm, preferably 3 mm. The lamp base has a bottom panel, of which a perimeter has a sidewall extending upwardly and aggregated with the top panel. The lamp base further has a top panel adjacent to the sidewall. The lamp base and the top panel formed of glass are glued together with a glass glue to construct a closed cavity. An interior surface of the top panel is coated with a fluorescent layer that covers a portion of the top panel. An interior surface of the bottom panel is coated with a fluorescent layer that covers a portion of the bottom panel. Thus arranged, the fluorescent layers are formed within the bottom and top panels. A set of electrodes is formed within the closed cavity. By applying a high voltage, electrons are induced by the electric field between the electrodes. The electrons bombard with an inert gas or a mercury vapor filled in the close cavity to emit an ultra-violet light. The ultra-violet light then excites the fluorescent layers to emit various color lights. Since fluorescent layers formed of fluorescent materials able to emit various color lights are coated on the interior surfaces of the bottom and top panels, various color lights are obtained. An interior surface of the top panel is coated with a fluorescent layer which covers a portion of the top panel. In the above light source structure, the lamp base with a sidewall can be formed by blasting without using an additional glass side strip or spacer. The fabrication process is simplified, and the fabrication cost is reduced. Further, the process window is enlarged with the sidewall fabricated on the same base. As a consequence, the product yield is enhanced. The interior surface of the cavity, the gas container, constructed by the panels and sidewall can be coated with fluorescent layer. Accompanied with the electrodes disposed in the cavity, a planar light source with uniform and high brightness is obtained.

In yet another embodiment, a color fluorescent lamp with a patterned fluorescent layer is provided. The fluorescent lamp has similar structure to the one described above. However, the patterned fluorescent layer presents a required mark or image as required.

The patterned fluorescent layer can also applied to the third embodiment of the invention to obtain the required mark on the top and/or bottom panels by coating one or more than one patterned fluorescent layers.

Both the foregoing general description and the following detailed description are exemplary and explanatory only and are not restrictive of the invention, as

### BRIEF DESCRIPTION OF THE DRAWINGS

FIG. 1 is a cross sectional view showing the color fluorescent lamp in the first embodiment of the invention;

FIG. 2 is a cross sectional view showing the color fluorescent lamp in the second embodiment of the invention;

FIG. 3 is an exploded view showing the color fluorescent lamp in the third embodiment of the invention;

FIG. 4A shows a color fluorescent lamp with a patterned fluorescent layer in a fourth embodiment of the invention;

FIGS. 4B and 4C show the cross section cutting along I-I′ in FIG. 4A; and

FIG. 5 shows the cross sectional view of a patterned planar color fluorescent lamp in a fifth embodiment of the invention.

### DESCRIPTION OF THE PREFERRED EMBODIMENTS

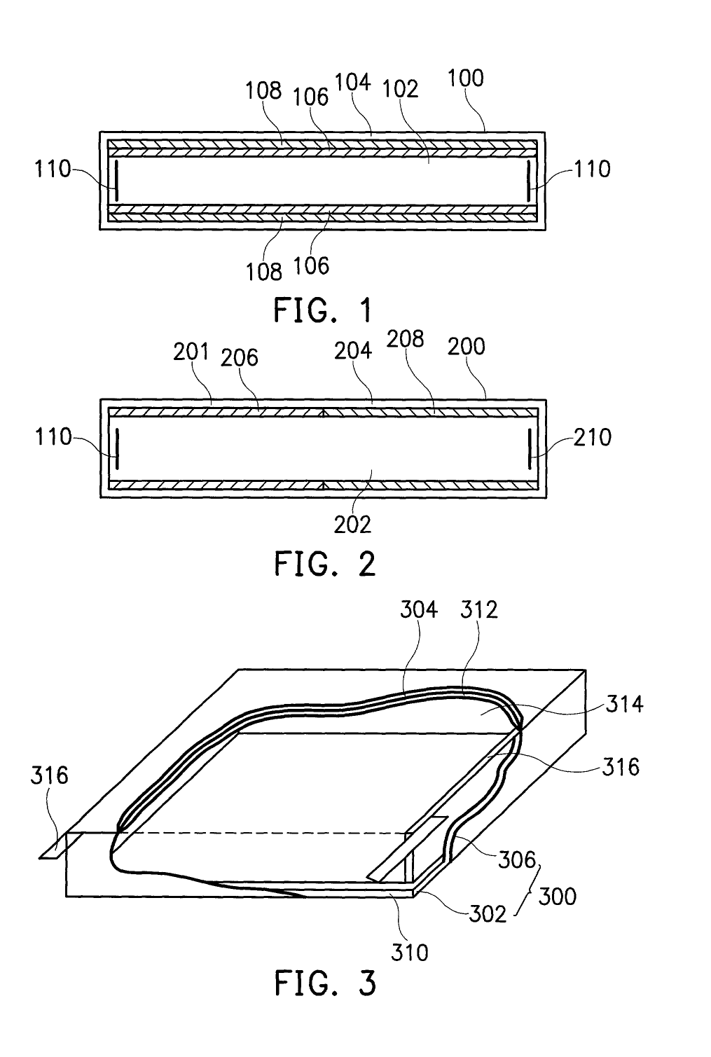

Referring to FIG. 1, a cross sectional view of a color fluorescent lamp is shown. The color fluorescent lamp 100 includes a closed cavity 102. For example, the closed cavity 102 is formed of glass, such as soda-lime glass Corning®0800 or Corning®7059 manufactured by Corning Glass Corp. An inert gas or a mercury vapor is filled in the cavity 102. On an interior wall 104 of the cavity 102, fluorescent layers 106, 108 are coated. The fluorescent layers 106, 108 may be formed of materials that can emit different color lights The method for forming the fluorescent layers 106, 108 includes screen printing, wet dip and electrostatic coating, while the material of the fluorescent layers 106, 108 includes phosphor. For example, tri-wavelength phosphor to absorb an ultra-violet light in order to emit a red light, a green light and a blue light. In addition, in the closed cavity 102, a set of electrodes 110 is applied with a high voltage to induce electrons bounding from one electrode to the other. The electrons bombard with the inert gas or mercury vapor in the close cavity to emit an ultra-violet light, by which the fluorescent layers 106, 108 are excited to emit visible lights. Since the fluorescent layers 106, 108 are able to emit different color lights, by the mixture of lights and based on the three primary colors, any required color can be obtained by using fluorescent materials that may emit red, green, blue and white color lights. Further, by controlling the thickness of the fluorescent layers, the intensities of three primary color lights and the white color light, the color scale and the gray scale can be adjusted.

Referring to FIG. 2, a cross sectional view for a color fluorescent lamp is illustrated. The color fluorescent lamp 200 comprises a closed cavity 202, of which the material includes glass 201 including soda lime glass, for example, the Corning®0800 glass or Corning®7059 glass. An inert gas or a mercury vapor is filled in the closed cavity 202. An interior wall 204 of the closed cavity 202 is divided into two regions 206, 208. Fluorescent layers are coated on the regions 206, 208. The method for coating the fluorescent layers on the regions 206, 208 includes screen printing, wet dip and electrostatic coating. The material of the fluorescent layers includes phosphor, for example, tri-wavelength phosphor able to absorb ultra-violet light, so as to emit red, green and blue lights. A set of electrodes 210 disposed in the closed cavity 202 is applied with a high voltage that induces electrons to leap from one electrode to the other. The inert gas or mercury vapor is bombarded and excited by the electrons to emit an ultra-violet light. The fluorescent layers coated on the regions 206, 208 are then excited by the ultra-violet light to emit various color lights. By the mixture of lights and based on the three primary colors, any required color can be obtained by using fluorescent materials that may emit red, green, blue and white color lights. Further, by controlling the thickness of the fluorescent layers, the intensities of three primary color lights and the white color light, the color scale and the gray scale can be adjusted.

Referring to FIG. 3, a cross sectional view for a planar color fluorescent lamp is shown. The fluorescent lamp has a lamp base 300 with a thickness of about 2 mm to about 5 mm, preferably, 3 mm The lamp base 300 has a bottom panel 302. From a perimeter of the bottom panel 302, a sidewall 306 extends upwardly to join a top panel 304. The bottom panel 302, the sidewall 306 and the top panel 304 are aggregated together. The material of the base 300 and the top panel 304 includes glass such as soda-lime glass. For example, the glass may be selected from the Corning ®0800 glass or the Corning®7059. The base 300 and the top panel 304 may be joined together using a glass glue such as the Corning®7575 or Corning®1301 fabricated by Corning Glass Corp. On interior surfaces of the bottom panel 302 and the top panel 304, fluorescent layers 310 and 312 are coated, respectively. The fluorescent layers 310, 312 are thus located between the lamp base 300, the bottom panel 302 and the top panel 304 which construct a closed cavity 314. In the airtight closed cavity 314, a set of electrodes 316 is applied with a high voltage that induce electrons to leap from one electrode to the other. The electrons bombard with an inert gas or a mercury vapor filled in the closed cavity 314 to emit an ultra-violet light. The fluorescent layers 310 and 312 are excited to emit a visible light. Since the fluorescent layers 310 and 312 are able to emit different color lights, by the mixture of lights and based on the three primary colors, any required color can be obtained by using fluorescent materials that may emit red, green, blue and white color lights. Further, by controlling the thickness of the fluorescent layers 310, 312, the intensities of three primary color lights and the white color light, the color scale and the gray scale can be adjusted. In such a light source structure, the lamp base 300 with the sidewall 306 is made using blasting, so that an addition glass side strip is not required A gas container of the close cavity 314 is constructed within the lamp base 300, the bottom panel 302 and the top panel 304. With the formation of fluorescent layers 310, 312 and electrodes disposed in the close cavity 314, a light source with a planar illumination with a high and uniform brightness can be obtained.

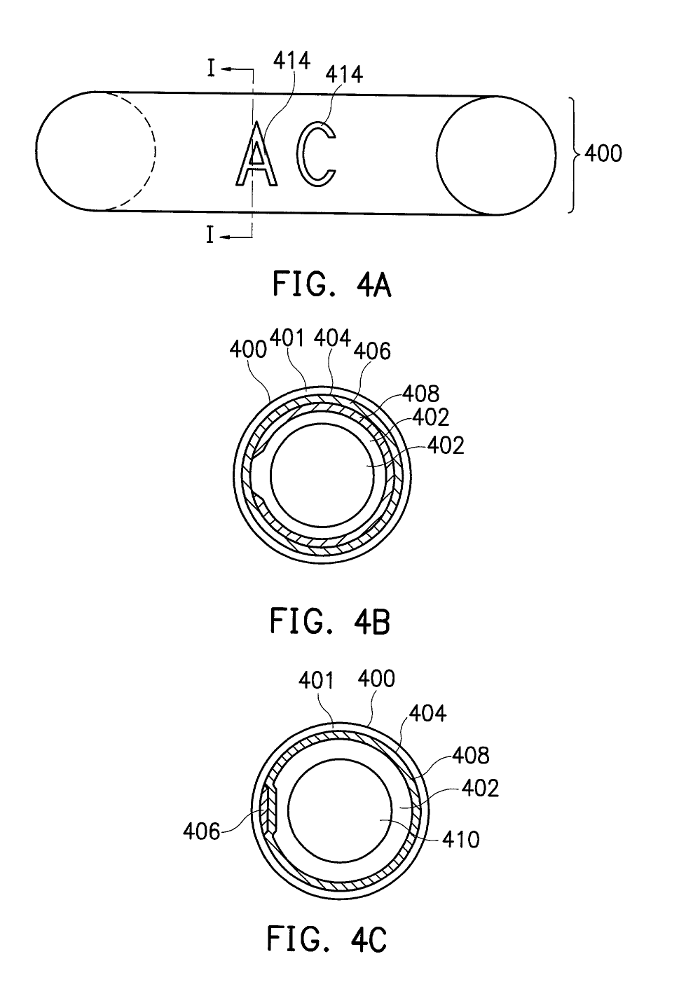

FIG. 4A schematically shows a color fluorescent lamp The color fluorescent lamp 400 comprises a close cavity 402. Referring to FIGS. 4B and 4C, the material for forming the close cavity 402 includes a glass 401 such as the soda-lime glass. The soda-lime glass can be selected from the Corning®0080 glass and the Corning®7059 glass. An inert gas or a mercury vapor is filled in the closed cavity 402. Two fluorescent layers 406, 408 are coated on an interior wall 404 of the closed cavity 402 The method for coating the fluorescent layers 406, 408 on the interior wall 404 includes screen printing, wet dip and electrostatic coating. The material of the fluorescent layers includes phosphor, for example, tri-wavelength phosphor able to absorb ultra-violet light, so as to emit red, green and blue lights A set of electrodes 410 disposed in the closed cavity 402 is applied with a high voltage that induces electrons to leap from one electrode to the other. The inert gas or mercury vapor is bombarded and excited by the electrons to emit an ultra-violet light. The fluorescent layers 406, 408 are then excited by the ultra-violet light to emit visible light Since the fluorescent layers 406, 408 may emit different color lights, the position coated with a pattern 414 of either the fluorescent layer 406 or 408, only the color light emitted thereby is obtained. In other positions, by the mixture of lights and based on the three primary colors, color other than the one emitted from the fluorescent lights 406, 408 can be obtained. Or alternatively, only the position with the pattern 414 presents the mixed color light of the fluorescent layers 406 and 408, while other positions display single color light of either the fluorescent layer 406 or 408

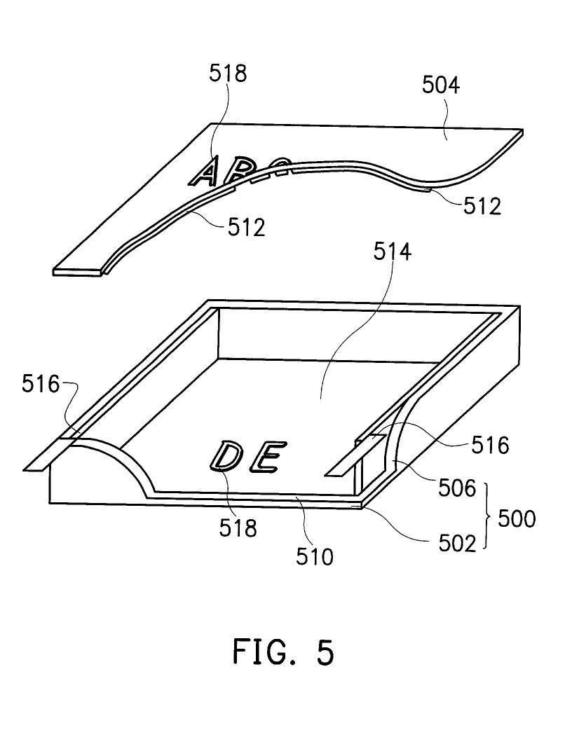

Referring to FIG. 5, a cross sectional view for a planar color fluorescent lamp is shown. The fluorescent lamp has a lamp base 500 with a thickness of about 2 mm to about 5 mm, preferably, 3 mm. The lamp base 500 has a bottom panel 502. From a perimeter of the bottom panel 502, a sidewall 506 extends upwardly to join a top panel 504. The bottom panel 502, the sidewall 506 and the top panel 504 are aggregated together. The material of the base 500 and the top panel 504 includes glass such as soda-lime glass For example, the glass may be selected from the Corning®0080 glass or the Corning®7059. The base 500 and the top panel 504 may be joined together using a glass glue such as the Corning®7575 or Corning®1301 fabricated by Corning Glass Corp. On interior surfaces of the bottom panel 502 and the top panel 504, fluorescent layers 510 and 512 are coated, respectively. The fluorescent layers 510, 512 are thus located between the lamp base 500, the bottom panel 502 and the top panel 504 which construct a closed cavity 514. A pattern is transferred on the fluorescent layers 510, 512. Or alternatively, a patterned fluorescent layer may be formed on the fluorescent layers 510, 512. In the airtight closed cavity 514, a set of electrodes 516 located at two opposing sides is applied with a high voltage that induce electrons to leap from one electrode to the other. The electrons bombard with an inert gas or a mercury vapor filled in the closed cavity 514 to emit an ultra-violet light. The fluorescent layers 510 and 512 are excited to emit a visible light. Since the fluorescent layers 510 and 512 are able to emit different color lights, by the mixture of lights and based on the three primary colors, any required colored pattern 520 can be obtained at the position by using fluorescent materials that may emit red, green, blue and white color lights. By adding another fluorescent layer, different color light can further be obtained.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A color fluorescent lamp, comprising:
a closed cavity, filled with at least an inert gas;
at least two fluorescent layers, coated on an interior wall of the closed cavity, wherein the fluorescent layers contain fluorescent materials able to emit various color lights; and
a set of electrodes, disposed in the closed cavity and applied with a high voltage.

2. The color fluorescent lamp according to claim 1, wherein a mercury vapor can be filled in the closed cavity in addition to the inert gas.

3. A color fluorescent lamp, comprising:
a closed cavity, filled with at least an inert gas;
at least two fluorescent regions, inside of the closed cavity and coated with at least two kinds of fluorescent materials able to emit different color lights; and
a set of electrodes, in the closed cavity applied with a high voltage.

4. The color fluorescent lamp according to claim 3, wherein a mercury vapor is added in the closed cavity in addition to the inert gas.

5. A color planar fluorescent lamp, comprising:
a lamp base, with a first panel, from which a sidewall extends upwardly from a perimeter;
a second panel, adjacent to the sidewall over the lamp base;
a first fluorescent layer, covering a portion of an interior surface of the first panel, the first fluorescent layer having at least a first fluorescent material;
a second fluorescent layer, covering a portion of an interior surface of the second panel, the second fluorescent layer having at least a second fluorescent material different from the first fluorescent material; and
a set of electrodes, located on two opposing sides enclosed by the sidewall between the lamp base and the second panel.

6. The color planar fluorescent lamp according to claim 5, wherein the lamp base and the second panel are made of glass.

7. The color planar fluorescent lamp according to claim 5, further comprising a glass glued to connect the sidewall and the second panel.

8. A color fluorescent lamp with a pattern, comprising.
a closed cavity, filled with an inert gas therein;
at least a patterned fluorescent layer, coated on an interior wall of the close cavity to display a required mark; and
a set of electrodes, located in the closed cavity and applied with a high voltage.

9. The patterned color fluorescent lamp according to claim 8, wherein a mercury vapor is added in the closed cavity.

10. A color planar fluorescent lamp with a pattern, comprising:
a lamp base, with a first panel, of which a sidewall extending upwardly from a perimeter and aggregated with the first panel,
a second panel, adjacent to the sidewall over the lamp base;
a first fluorescent layer, covering a portion of an interior surface of the first panel, the first fluorescent layer having at least a first fluorescent material or a patterned fluorescent material;
a second fluorescent layer, covering a portion of an interior surface of the second panel, the second fluorescent layer having at least a second fluorescent material or a patterned fluorescent material; and
a set of electrodes, located on two opposing sides enclosed by the sidewall between the lamp base and the second panel.

11. The color planar fluorescent lamp according to claim 10, wherein the lamp base and the second panel are made of glass.

12. The color planar fluorescent lamp according to claim 10, further comprising a glass glued to connect the sidewall and the second panel.

13. The color planar fluorescent lamp according to claim 10, wherein the first or the second fluorescent layer comprises at least a patterned fluorescent layer.
